(19) United States
(12) Patent Application Publication
(10) Pub. No.: US 2004/0268132 A1
(43) Pub. Date: Dec. 30, 2004

(54) Radio frequency identification (RFID) based network access management

(75) Inventor: Heikki Waris, Tokyo (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/610,974

(22) Filed: Jun. 30, 2003

(51) Int. Cl. H04K 1/00

(52) U.S. Cl. 713/185; 340/5.74; 340/5.8

(57) ABSTRACT

A user terminal includes an RFID reader. When the user swipes or otherwise places the reader in proximity to a compatible RFID tag, the RFID tag sends a set of information to the terminal. This set of information contains the identifier of the preferred network point of connectivity (e.g. an IP address), as well as possible authentication information. Because of the short range, the information is not broadcast to a large audience. The information can also be encrypted, in which case only previously known keys allow the terminal to use the tags.

### TECHNICAL FIELD

This invention relates generally to wireless communications systems and methods and, more specifically, relates to RFID based network access management

### BACKGROUND

The existing and continuously expanding use of data mining technologies by corporations are leading to the complete loss of privacy for any individual who is active on-line. This in turn leads to self-censorship and a decrease in the on-line activity of individuals, which results in smaller markets for companies providing the means for truly personal communications and expression.

A first problem is how to connect to a preferred network when the gateway is unknown, and the terminal doesn't have the required authorization. A second problem is how to enforce physical or social (i.e. human-to-human) authorization easily. A third problem is how to securely deliver authorization key material asynchronously and off-line.

Prior art solutions have included the use of manual settings learned with out-of-band methods, such as entering configuration settings directly by hand, the use of DHCP (Dynamic Host Configuration Protocol) for managed network parameters where the client obtains the network configuration information directly from a server over an IP network, and the use of autoconfiguration for unmanaged network parameters where the configuration settings are obtained from IP network nodes. Other prior art solutions have included the use of authentication procedures based on passwords, SIM or smart cards to gain authorization from the access controller. Protocols such as AAA (Authentication, Authorization, Accounting) are required in the network for this solution. Additional prior art solutions have included the use of prior security associations, such as IPSec SA, with any connection where the terminal stores the access information locally, and use of Mobile IPv6 handover extensions to learn a best new access router.

The following drawbacks have been identified in the above prior art solutions. First, manual settings don't readily scale. Second, network parameter configuration without access authorization carries the risk of malevolent users denying the service from others. Further, network parameter configuration alone does not indicate which of the possibly available networks should be joined. Third, infrastructure-based authorization requires communication over networks, as well as agreements and contracts or trust between participants. It also introduces delays. The use of prior SA's (security associations) assumes either long-standing SA's, or frequent updates and a large set of SA material. The first option degrades security, and the latter creates management overhead. The storage of a large set of SA material, especially if they are shared, is a security risk.

Fourth, the Mobile IPv6 extensions expect some relationship between the old and the new access router, possibly over the AAA infrastructure. Fifth, although RFID use for service discovery is well known, its use in lower layer network connectivity as a replacement for network-oriented methods is not common. In a normal case, the terminal that reads a tag is assumed to know how to contact the service, or the service is local. Sixth, regular access control and key management mechanisms assume either on-line connectivity, or easily traceable/interceptable off-line exchange or synchronous momentary proximity of communicating parties. Most key management and access methods can be attacked using either automation or brute force (scanning remotely or in wide areas). The user and his status is ignored (digital authentication assumed sufficient).

### SUMMARY OF THE PREFERRED EMBODIMENTS

The foregoing and other problems are overcome, and other advantages are realized, in accordance with the presently preferred embodiments of these teachings.

The inventor has realized that when inexpensive RFID tags and readers become ubiquitous and controllable by individuals, they will be distributed into many places, both on static surfaces and in worn, carried or otherwise mobile objects. The increasing use and acceptance of this technology will result in new opportunities for services creation and management. RFID tags and readers offer a unique way to assist in basic network connectivity solutions.

By taking advantage of the properties of RFID (or any other similar short-range, ubiquitous and inexpensive mechanisms), a new solution to the privacy problem becomes possible. These same properties can also be used as an everyday access solution, where it solves a different kind of problem (and can better lead to new, real business).

This invention provides that the information required for access is available without any network connectivity. There need not be any state in the terminal, or knowledge by the user, related to the new network. The access control can be physical, allowing a human to authenticate and authorize the user personally and/or prevent automated electronic or physical attacks. If network connectivity or authorization infrastructure is not used, anonymous on-demand, pre-paid use is possible.

### BRIEF DESCRIPTION OF THE DRAWING

The foregoing and other aspects of these teachings are made more evident in the following Detailed Description of the Preferred Embodiments, when read in conjunction with the attached Drawing Figures, wherein:

FIG. 1 is a simplified block diagram of an embodiment of a wireless communications system that is suitable for practicing this invention.

FIG. 2 is a simplified block diagram of an embodiment of a wireless communications system that comprises two RFID tags, a shield to prevent broadcast of tag information and a key management system.

FIG. 3 is a simplified block diagram of an embodiment of a wireless communications system where a first RFID tag comprises a clear text address of the Access Point and a second RFID tag comprises a decryption key.

FIG. 4 is a simplified block diagram of an embodiment of a wireless communications system where the first RFID tag comprises a decryption algorithm and key for the second RFID tag and the second RFID tag comprises the clear text Access Point address.

FIG. 5 is a simplified block diagram of an embodiment of a wireless communications system where the first RFID tag comprises the local or remote access controller's IP address and the second RFID tag comprises the decryption key.

FIG. 6 is a simplified block diagram of an embodiment of a wireless communications system where the first RFID tag comprises a decryption algorithm and key for the second RFID tag and the second RFID tag comprises the local or remote access controller's IP address.

FIG. 7 is a simplified block diagram of an embodiment of a wireless communications system where the first RFID tag comprises an Access Point channel, network name and Wired Equipment Privacy key instead of the IP layer address and the second RFID tag comprises the decryption key.

FIG. 8 is a simplified block diagram of an embodiment of a wireless communications system where the first RFID tag comprises a decryption algorithm and key for the second RFID tag and the second RFID tag comprises an Access Point channel, network name and Wired Equipment Privacy key in addition to the local or remote access controller's IP address.

FIG. 9 is a simplified diagram of the seven layer Open Systems Interconnection (OSI) Model.

FIG. 10 is a simplified block diagram of an embodiment of a wireless communications system that comprises an RFID tag or tags and user terminals coupled with RFID readers in proximity to each other in a non-networked location.

FIG. 11 is a simplified block diagram of a user terminal, or mobile station, where the mobile station is coupled with an RFID reader.

### DETAILED DESCRIPTION OF THE PREFERRED EMBODIMENTS

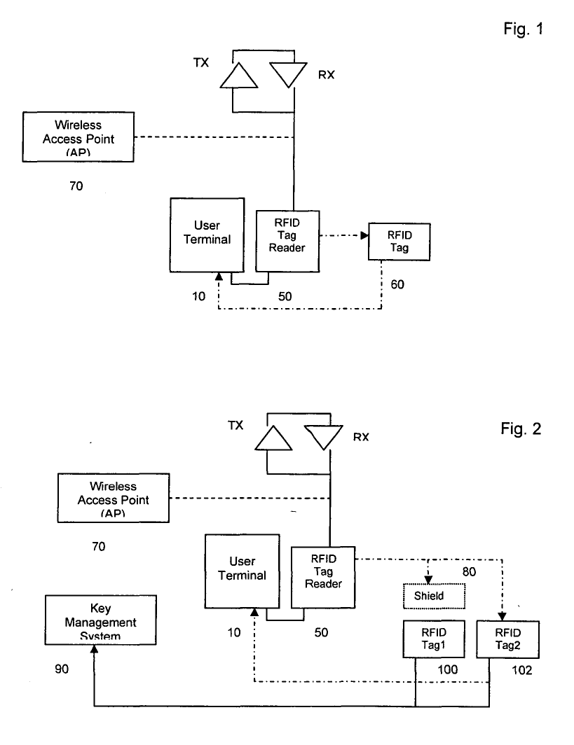

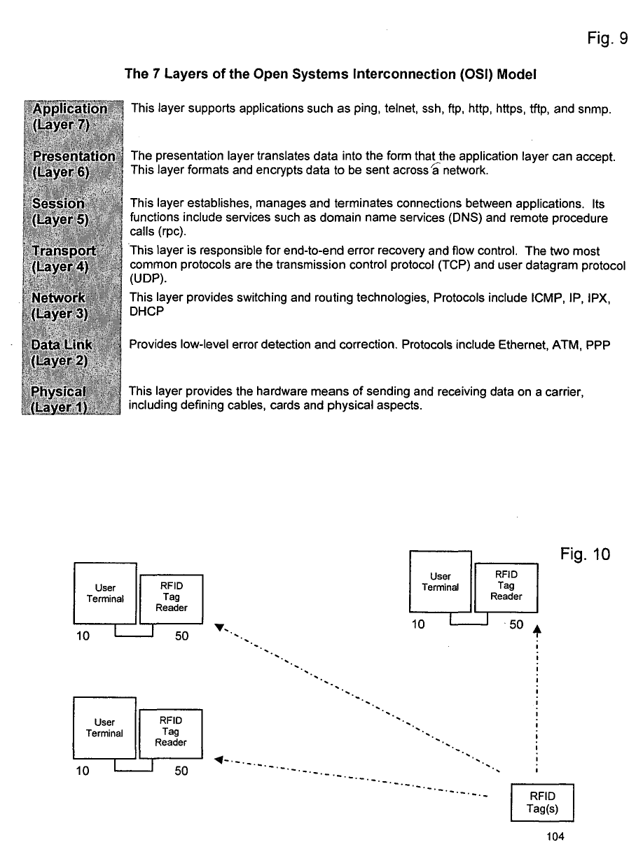

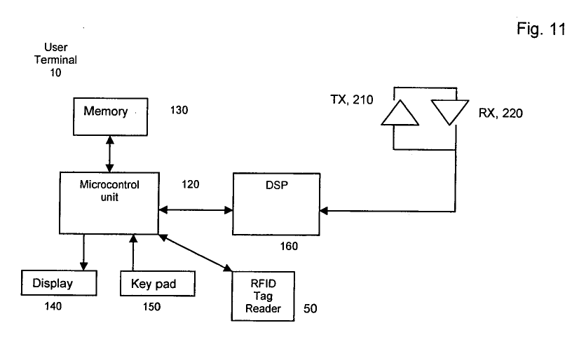

The invention uses inexpensive RFID tags in a novel way (FIG. 1). Instead of higher layer service information, an RFID tag 60 conveys link-layer and/or IP layer information (FIG. 9). This is used by a terminal 10 with an RFID reader 50 (FIG. 11) to gain network connectivity. The point of internet connectivity can be chosen from a multitude of competing alternatives (e.g. cellular and unregulated wireless access, ad-hoc and proximity networks).

A user terminal 10 includes an RFID reader 50. When the user swipes or otherwise places the RFID reader 50 in proximity to a compatible RFID tag 60, the RFID tag 60 sends a set of information to the terminal 10. This set of information contains the identifier of the preferred network point of connectivity (e.g. an IP address), as well as possible authentication information. Because of the short range, the information is not broadcast to a large audience. The information can also be encrypted, in which case only previously known keys allow the terminal 10 to use the information transmitted by the RFID tag 60.

In a typical use scenario, (FIG. 2) a cafe operates (itself or by a Wireless Internet Service Provider (WISP)) a wireless access point (AP) 70, but wants to advertise to and authorize only its customers. A person who is just sitting on the bench outside, or even a non-paying visitor to the cafe, would not be allowed access, even if they would be authorized in the WISPs other service locations. The cafe teller has two RFID tags 100 and 102 (one for the AP's address, the other for a decryption key) disposed under a shield 80, through which the weak signal can't penetrate. Alternatively, only the decryption key is shielded and free access is provided to local resources.

After the customer has purchased food and drinks, the clerk slides open the shield 80 that reveals two RFID tags 100 and 102. The user swipes or otherwise places the RFID reader 50 in proximity to RFID Tag1 100 and directly after that over RFID Tag2 102. The RFID tags 100 and 102 may be replaced periodically, though not necessarily at regular intervals, with new RFID tags matching updated access keys in the AP 70. The RFID tags 100 and 102 may be connected to a key management system 90 that can rewrite the contents of the tag. In this case the keys could be personal and have exact and finely controllable lifetimes, making the system behave analogous to inband key distribution.

Combinations of Two RFID Tags

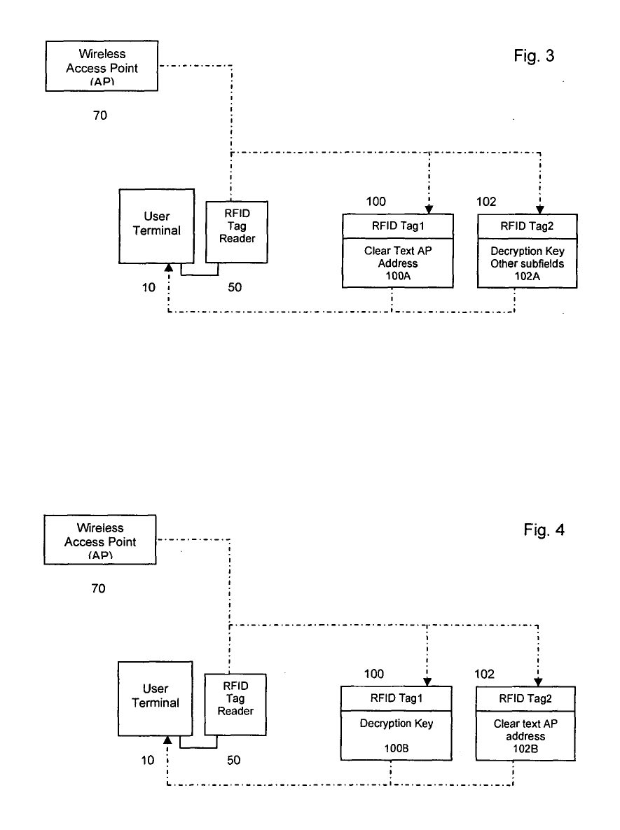

1. RFID Tag1 100 (FIG. 3) includes the clear-text address 100A of the preferred AP 70 and RFID Tag2 102 includes the decryption key 102A for encrypted advertisements sent by the AP 70, which contain e.g. the public key required for access control over an otherwise shared link. The algorithm is specified either in RFID Tag 1 100 or in a clear-text AP advertisement.

2. RFID Tag1 100 (FIG. 4) includes a decryption algorithm and key 100B for RFID Tag2 102, which includes a clear-text AP address 102B. The AP 70 is presently passive, but responds to solicitations sent outside the clear-text access link, and/or its advertisements can be decrypted using the same material as in RFID tag decryption.

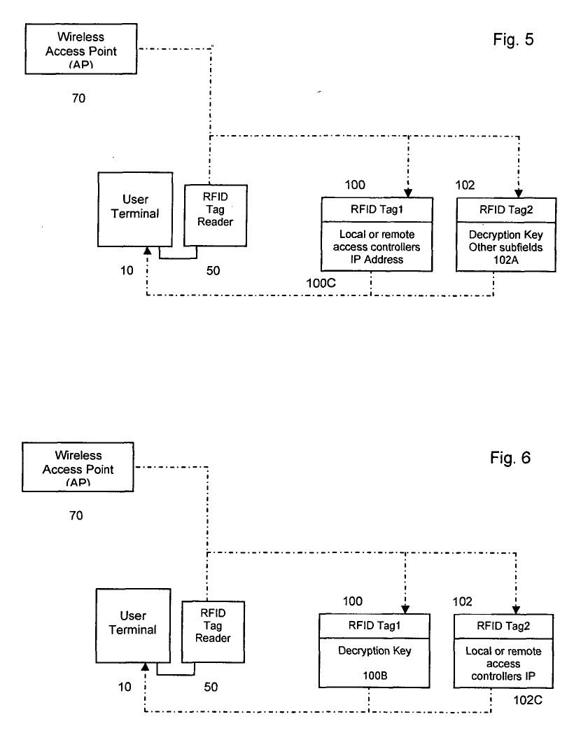

3. As in 1 or 2 cited above, but having the local or remote access controller's IP address 100C (e.g. the public internet gateway of the WISP) instead of the AP address. (FIG. 5 and FIG. 6)

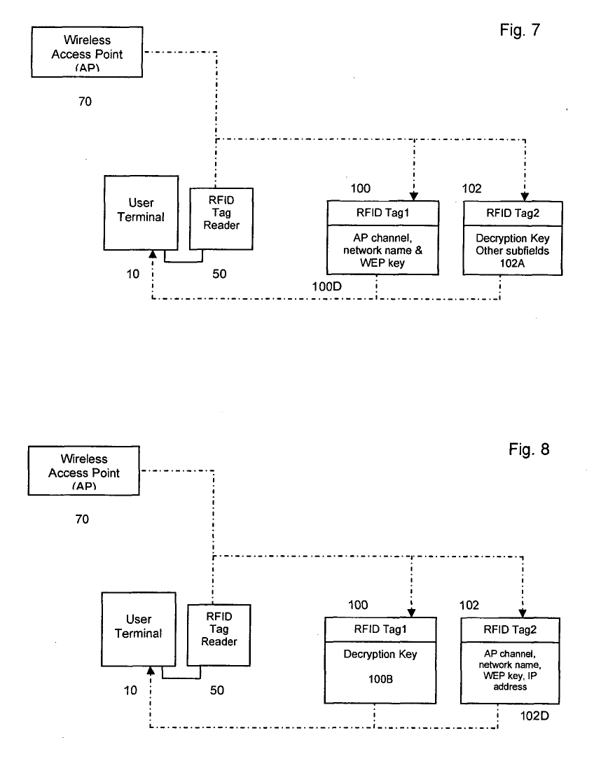

4. As in 1 or 2 cited above, but having e.g. an AP channel, network name and WEP (Wired Equipment Privacy) key 100D which offers encrypted communications using a secret key shared between an access point and terminal (link-layer access control information) instead of or in addition to the IP layer address 102D. (FIG. 7 and FIG. 8)

5. As in any of the four listed cases above (FIG. 3-FIG. 8), but where two need to be combined to obtain a message that includes both an AP address and decryption material. This is similar to decrypting one RFID tag with the other one, but is independent of the order in which tags are applied, and doesn't include any clear-text data (such as an algorithm).

By introducing standardized classification of tag types, a longer sequence of tags could convey a full set of access control information (excluding service information that is not required in the access decision making process and access attempt). Example tag types include an algorithm and key used for decrypting the next tag in the sequence; availability and/or price of access (local/global/extra service); link layer type, and type specific subfields (e.g. network name, WEP key); preferred AP IP version and version-specific address; access controller IP version and version-specific address; local service type address (e.g. for DNS (Domain Name System)) or URI (Uniform Resource Identifier, for generic services).

Examples of embodiments of RFID tags, more specifically their data contents are shown below.

Example key material RFID tag 100B and 102A:

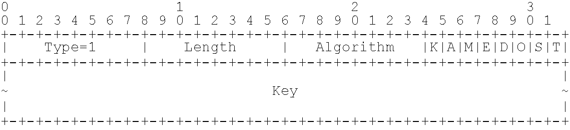

| | |
|---|---|
| Length | length of tag contents in octets |
| Algorithm | index value for e.g. 3DES, RSA, etc. |
| K | flag: combine with key with next key tag key |
| A | flag: combine with algorithm with key tag algorithm |
| M | flag: apply this key to multiple tags (until next key) |
| E | flag: use key for encryption |
| D | flag: use key for decryption |
| O | flag: one-time key |
| S | flag: key is seed for subsequent keys |
| T | flag: key is used tags (not for e.g. AP advertisements) |
| Key | key used with the algorithm |

Example access availability RFID tag 102A:

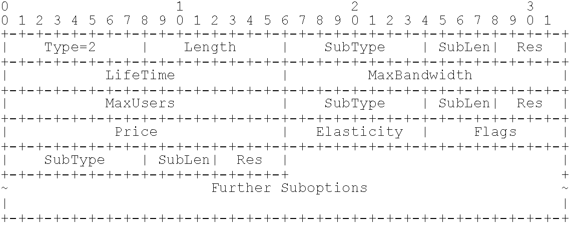

| | |
|---|---|
| Length | length of tag contents in octets |
| SubType | type of next suboption contents |
| SubLen | length of suboption contents in octets (O = rest of tag) |
| Res | reserved for extensions (e.g. flags) |
| LifeTime | example suboption: lifetime of the keys/addresses (min) |
| MaxBandwidth | example suboption: bandwidth cap (kB/sec) |
| MaxUsers | example suboption: max number of simultaneous users |
| Price | example suboption: bandwidth allocation cost ($/(kB/sec)) |
| Elasticity | example suboption: type of progression (flat/log/lin/exp) |
| Flags | example suboption: progression sources (e.g. bw, users) |

Example link layer RFID tag 100D:

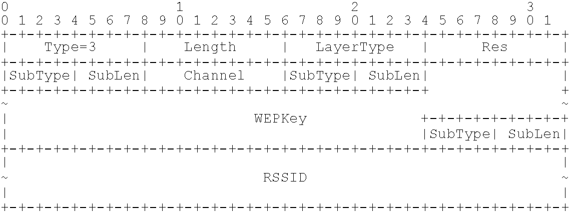

| | |
|---|---|
| Length | length of tag contents in octets |
| LayerType | type of link layer, e.g. 802.11b |
| SubType | type of next suboption contents |
| SubLen | length of suboption contents in octets (O = rest of tag) |
| Res | example suboption (reserved for later specification) |
| Channel | example suboption: 802.11b channel |
| RSSID | example suboption: 802.11b RSSID (ASCII) |

The combination of encrypted tags and point-to-point short range exchange (FIG. 10) allows the creation of clandestine, non-networked access mechanism in selected locations. For example, a group of friends could inform each other about websites in a timing-independent (asynchronous) broadcast by leaving tags in a place known primarily to the group, and encrypted using keys known only to them. This information exchange would not be visible to outsiders (in public networks), and it would not require synchronization of the terminals 10 when the users are simultaneously in the same place (proximity). The main content of the messages is preferably not stored in the tag 104, however, the use of the tag(s) 104 allow the sharing of that information with less risk of detection or behavioral pattern matching. Also, this method adds two new elements to the digital authorization process: physical restrictions (because of very close proximity required by the tag) and human knowledge (in order to locate and recognize the tags using clues that can only be understood by a human member of the group). This increases the cost of an attack against the access control system.

As an alternative to having (one or more) tags with both key material and connectivity information (address), and as was shown in FIG. 1, only one key tag may be used 60. The one RFID tag 60, in this case, could contain both the algorithm and the key. This key material would then be used in attempts to decrypt any seemingly encrypted traffic (primarily traffic that is detected in the immediate proximity of the tag 60 using all available access technologies, but possible in a location known from other sources). Alternatively, the RFID tag 60 would have just the key, and the RFID reader 50 would either attempt several algorithms until communication was established, or use knowledge from other sources to choose the appropriate algorithm.

However, all such and similar modifications of the teachings of this invention will still fall within the scope of this invention, for example, although descriptive content of certain data fields and contents in the RFID tags are illustrated, these are not intended to be exhaustive of combinations comprising data fields and contents of the RFID tags. Further, while the method and apparatus described herein are provided with a certain degree of specificity, the present invention could be implemented with either greater or lesser specificity, depending on the needs of the user. Further, some of the features of the present invention could be used to advantage without the corresponding use of other features. As such, the foregoing description should be considered as merely illustrative of the principles of the present invention, and not in limitation thereof, as this invention is defined by the claims which follow.

What is claimed is:

1. A method for radio frequency identification based network access management comprising:
providing a terminal that comprises an RFID reader;
wirelessly coupling to at least one RFID tag external to said terminal; and
initiating an authentication process whereby at least one of link layer information and IP layer information is sent from the at least one RFID tag to the terminal.

2. A method as described in claim 1, where the information comprises the identifier of a preferred network point of connectivity.

3. A method as described in claim 1, where the information comprises authentication information.

4. A method as described in claim 1, where the information is sent in an encrypted format.

5. A method as described in claim 1, where the information is sent in an unencrypted format.

6. A method as described in claim 1, where the information is utilized to gain network connectivity.

7. A method as described in claim 1, where the point of internet connectivity comprises a cellular access network.

8. A method as described in claim 1, where at least two RFID tags are used:
where a first RFID tag comprises an Access Point address; and
a second RFID tag comprises a decryption key.

9. A method as described in claim 1, where at least one RFID tag may be disposed under a shield that attenuates a signal transmitted by said tag.

10. A method as described in claim 1, where said RFID tag is periodically replaced with another RFID tag that stores an updated access key to the Access Point.

11. A method as described in claim 1, where said RFID tag is wirelessly coupled to a key management system to rewrite the contents of said RFID tag.

12. A method as described in claim 1, where at least two RFID tags are used:
where a first RFID tag comprises a clear text address of the Access Point; and
a second RFID tag comprises a decryption key for encrypted broadcasts sent by the Access Point.

13. A method as described in claim 1, where at least two RFID tags are used:
where a first RFID tag comprises a decryption algorithm and key; and
a second RFID tag comprises a clear text address of the Access Point.

14. A method as described in claim 1, where at least two RFID tags are used:
where a first RFID tag comprises the local or remote access controller IP address; and
a second RFID tag comprises a decryption key.

15. A method as described in claim 1, where at least two RFID tags are used:
where a first RFID tag comprises a decryption algorithm and key; and
a second RFID tag comprises the local or remote access controller IP address.

16. A method as described in claim 1, where at least two RFID tags are used:
where a first RFID tag comprises an Access Point channel, network name and Wired Equipment Privacy key; and
a second RFID tag comprises a decryption key.

17. A method as described in claim 1, where at least two RFID tags are used:
where a first RFID tag comprises a decryption algorithm and key; and
a second RFID tag comprises the local or remote access controller IP address, Access Point channel, network name and Wired Equipment Privacy key.

18. A method as described in claim 1, where at least one RFID tag comprises a key material tag.

19. A method as described in claim 1, where at least one RFID tag comprises an access availability tag.

20. A method as described in claim 1, where at least one RFID tag comprises a link layer tag.

21. A mobile terminal, comprising a wireless transceiver, a data processor, and an RFID reader coupled to said data processor for receiving a transmission from at least one RFID tag, comprising information descriptive of at least one of link layer information and IP layer information for use by said mobile terminal for gaining access to a network.

22. A wireless communication system comprising a radio frequency identification based network access management system that includes a terminal that comprises a data processor and an RFID reader for being wirelessly coupled to at least one RFID tag external to said terminal, said data processor being responsive to information received via said RFID reader for initiating access to a network, said information comprising at least one of link layer information and IP layer information.

23. A wireless communication system as described in claim 22, where the information comprises the identifier of a preferred network point of connectivity.

24. A wireless communication system as described in claim 22, where the information comprises authentication information.

25. A wireless communication system as described in claim 22, where the information is sent in an encrypted format.

26. A wireless communication system as described in claim 22, where the information is sent in an unencrypted format.

27. A wireless communication system as described in claim 22, where the information is utilized to gain network connectivity.

28. A wireless communication system as described in claim 22, where the point of internet connectivity comprises a cellular access network.

29. A wireless communication system as described in claim 22, where said data processor is responsive to information received from at least two RFID tags, where information in a first RFID tag comprises an Access Point address and where information in a second RFID tag comprises a decryption key.

30. A wireless communication system as described in claim 22, where at least one RFID tag may be disposed under a shield that attenuates a signal transmitted by said tag.

31. A wireless communication system as described in claim 22, where said RFID tag is periodically replaced with another RFID tag that stores an updated access key to the Access Point.

32. A wireless communication system as described in claim 22, where said RFID tag is wirelessly coupled to a key management system to rewrite the contents of said RFID tag.

33. A wireless communication system as described in claim 22, where said data processor is responsive to information received from at least two RFID tags, where information in a first RFID tag comprises a clear text address of the Access Point and where information in a second RFID tag comprises a decryption key for encrypted broadcasts sent by the Access Point.

34. A wireless communication system as described in claim 22, where said data processor is responsive to information received from at least two RFID tags, where information in a first RFID tag comprises a decryption algorithm and key and where information in a second RFID tag comprises a clear text address of the Access Point.

35. A wireless communication system as described in claim 22, where said data processor is responsive to information received from at least two RFID tags, where information in a first RFID tag comprises the local or remote access controller IP address and where information in a second RFID tag comprises a decryption key.

36. A wireless communication system as described in claim 22, where said data processor is responsive to information received from at least two RFID tags, where information in a first RFID tag comprises a decryption algorithm and key and information in a second RFID tag comprises the local or remote access controller IP address.

37. A wireless communication system as described in claim 22, where said data processor is responsive to information received from at least two RFID tags, where information in a first RFID tag comprises an Access Point channel, network name and Wired Equipment Privacy key and information in a second RFID tag comprises a decryption key.

38. A wireless communication system as described in claim 22, where said data processor is responsive to information received from at least two RFID tags, where information in a first RFID tag comprises a decryption algorithm and key and information in a second RFID tag comprises the local or remote access controller IP address, Access Point channel, network name and Wired Equipment Privacy key.

39. A wireless communication system as described in claim 22, where the RFID tag comprises a key material tag comprising information that specifies an encryption algorithm.

40. A wireless communication system as described in claim 22, where the RFID tag comprises an access availability tag.

41. A wireless communication system as described in claim 22, where the RFID tag comprises a link layer tag.

42. An RFID tag comprising an RF device and data storage for storing information for use by a mobile device when initiating access to a wireless network node.

43. An RFID tag as described in claim 42, where said data storage stores key material information comprising an encryption algorithm used with the key and information descriptive of the use of the key.

44. An RFID tag as described in claim 42, where said data storage stores access availability information.

45. An RFID tag as described in claim 42, where said data storage stores link layer information.
